(19) United States
(12) Patent Application Publication
(10) Pub. No.: US 2005/0287501 A1
(43) Pub. Date: Dec. 29, 2005

(54) Method of aural rehabilitation

(75) Inventors: Robert W. Sweetow, Fairfax, CA (US); Jennifer Henderson-Sabes, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: REGENTS OF THE UNIVERSITY OF CALIFORNIA, Oakland, CA (US)

(21) Appl. No.: 11/145,006

(22) Filed: Jun. 3, 2005

Related U.S. Application Data
(60) Provisional application No. 60/579,039, filed on Jun. 12, 2004.

(51) Int. Cl. G09B 5/00

(52) U.S. Cl. 434/169; 434/236

(57) ABSTRACT

A method for neurological rehabilitation is disclosed. The method can be used for listening, comprehension and communication rehabilitation. The methods include a cognitive module, a degraded speech module, a competing speech module, a context module, and an interactive communication module.

### CROSS-REFERENCE TO RELATED APPLICATIONS

This application claims the benefit of U.S. provisional application No. 60/579,039, filed 12 June 2004, which is incorporated herein in its entirety for all purposes.

### BACKGROUND OF THE INVENTION

1. Field of the Invention

The present invention relates generally to a method for aural rehabilitation and/or therapy, such as for listening and comprehension.

2. Description of the Related Art

Increased age and hearing deficiencies can impair cognitive function, contextual skills, temporal processing and interactive communication skills. For example, individuals with sensorineural hearing loss (comprising over 90% of hearing aid users) have greater difficulty processing speech in noise than their normal hearing counterparts. Part of the reason for this difficulty relates to the reduction in tuning (i.e., broadened filters) in the peripheral auditory mechanism (i.e., the cochlea). However, another major cause for difficulty relates to the central auditory mechanism (i.e., brain). It has been shown experimentally that auditory deprivation as well as the introduction of novel stimuli lead to altered cortical representation (i.e., auditory plasticity). It is not clear whether this altered neuronal function will result in improved or diminished ability to understand speech in adverse conditions once audibility is fully or partially restored with wearable amplification.

Furthermore, the average hearing-impaired adult delays getting professional services for approximately seven years after first recognizing that a hearing impairment is present. This period of time is more than sufficient to develop compensatory listening habits that, again, may be beneficial or may be detrimental. Regardless, once a person begins wearing hearing aids, the brain must again adapt to a new set of acoustic cues. Currently, there is little treatment beyond the fitting of the hearing aid to the hearing loss. One would not expect an amputee to be furnished with a new prosthetic device without some type of physical therapy intervention, yet this is precisely what is done for people receiving new hearing devices.

Comprehension of speech through noises, such as background noise, can be difficult for aged and hearing deficient patients. Using a hearing aid to “turn up the volume” on both the speech and the noise does not necessarily make the speech easier to discern. Speech understanding in noise cannot be reliably predicted from the pure tone audiogram or other standard audiometric tests. Specific speech in noise tests (e.g., QuickSIN™ from Etymotic Research, Inc., Elk Grove Village, Ill.) can isolate patients' abilities to understand speech competing with noise. These tests, however, are used alone and merely for diagnostic purposes.

An exemplary speed of processing test, the Stroop test, consists of three parts: reading of color words, color naming, and an interference task. Stroop test subjects note the strong interference of word reading with color naming, called the Stroop interference effect (e.g. the word “red” printed in green requires the verbal response “green”). Additionally, a nomination score is quantified in terms of the difference in reaction times of reading of color words and color naming. The tendency to interference (selection) is quantified in terms of the difference in reaction times of color naming and the interference task. An activation of the frontal lobes occurs during the Stroop test in healthy subjects. The Stroop test has been used for diagnostic purposes, but not for aural rehabilitation purposes

Therefore there exists a need for a therapeutic method that more completely addresses neurological degradation associated with hearing impairments. There also exists a need for a method to address multiple neurological impairments associated with hearing impairments. There exists a need for a single, integrated training protocol and has not been available in a convenient, user-friendly, interactive program. Additionally, there exists a need for a therapeutic method that is completed at home, making it a cost effective procedure requiring very little time on the part of the clinician.

### BRIEF SUMMARY OF THE INVENTION

Methods for neurological rehabilitation are disclosed. These methods can be used for aural, comprehension, and communication rehabilitation. The methods include a cognitive module, a degraded speech module, a competing speech module, a context module, and an interactive communication module. The modules can be used in any combination with each other, and multiple individual modules can be used. As an example, a prescribed rehabilitation can include the use of two different cognitive modules, a degraded speech module, and two different context modules. As another example, a prescribed rehabilitation can include a cognitive module, a degraded speech module, a competing speech module, a context module, and an interactive communication module.

### BRIEF DESCRIPTION OF THE DRAWINGS

FIGS. 1A through 1C illustrate test results from objective measures on control and training groups before and after use of the methods disclosed herein.

FIGS. 2A through 2C illustrate test results from subjective measures on control and trained groups before and after use of the methods disclosed herein.

FIGS. 3A through 3E illustrate responses of the training group from a survey at the end of training.

FIG. 4A through 4E illustrate average improvement scores for the training group on the modules.

FIGS. 5A through 5C illustrate individual subjects' changes in scores.

FIG. 6 illustrates an embodiment of the method of aural rehabilitation.

### DETAILED DESCRIPTION

A method for neurological rehabilitation, such as aural rehabilitation, can include multiple exercise modules. Each module can be used to diagnose and/or provide treatment and/or therapy to a subject. The modules can be used as neurological training exercises. The modules can be cognitive modules, degraded speech modules, competing speech modules, context (i.e., contextual) modules, interactive communication modules, or combinations thereof. The cognitive modules can train, for example, auditory working memory and/or speed of processing. The context modules can address linguistics.

Cognitive Module

The cognitive modules, for example training auditory memory modules or working memory modules, can audibly play a series of words. The series of words can be a sentence. The subject can be asked to remember or recall an answer word in the series before a target word in the series. The subject can be asked to speak the answer word after the audible playing of the series.

The working memory module can be made more difficult, for example, by asking for multiple answer words for each series (e.g., “What comes before ‘seven’, ‘given’ and ‘fortune.’”), by playing multiple series (e.g., multiple sentences), by increasing the length and/or number of words in the series (e.g., longer sentences), by dividing the subject's attention, for example, with an additional memory task such as by asking the subject to answer questions regarding the substantive content of the series of words (e.g., “What did the dog do with the bone?”), or combinations thereof. The working memory module can be made less difficult, for example, by asking for less answer words for each series, by playing fewer series, by decreasing the length and/or number of words in the series (e.g., shorter sentences), or combinations thereof.

For example, the working memory module can ask the subject to say out loud the answer word that comes just before the target word. The target word in the following example can be “out.” The module can then audibly play the series of words, “The concert was sold out last week.” The answer word is “sold.”

The subject can repeat use of the cognitive modules. The target words and series of words can vary from one use to the next use.

The difficulty of the cognitive module can vary adaptively based on performance. A working memory and/or cognitive skill score can be recorded for the subject. If the subject responds with the correct answer word, the appropriate (e.g., working memory and/or cognitive) skill scores can be increased. If the subject responds with the incorrect answer word, the appropriate skill score can be decreased. As the working memory and/or cognitive skill score increases, the cognitive module can be made more difficult. As the working memory and/or cognitive skill score increases, the cognitive module can be made less difficult.

Other working memory modules can include, for example, use of digit, word, sentence, span, visio-spatial tests, or combinations thereof. The module can audibly play a sequence of numbers, letters, words, sentences or other data, for example the sequence “6, 2, 8.” The subject can be asked to reverse the order of the sequence, for example, the correct response to the sequence supra is “8, 2, 6.” Performing repeated tests for the Wechsler Adult Intelligence Scale (WAIS) can be used as a working memory module.

Performing repeated Pitch Pattern Sequence (PPS) tests can be used as a working memory module. PPS tests audibly play high frequency and low frequency tones of brief durations arranged in groups of three. The subject is evaluated based on the subject's correct recollection of the pattern of high and low frequencies. PPS tests are known to those having ordinary skill in the art.

The working memory module can, for example, present the subject with a number (e.g., five) of sentences. The subject can then be asked to determine if the sentences were meaningful, and to recall the last and/or first words in the sentences.

The cognitive modules can train the speed of neurological processing, for example, speech processing. The cognitive module can train the subject on auditory related tasks (e.g., the target and answer word cognitive module described supra) with the use of a timer. The subject can attempt to improve their best response time for each set of training data. The subject's response time can be incorporated into the subject's appropriate skill score, and/or a speed of processing skill score.

Existing neurological speed tests that can be modified for use in the cognitive module, such as for a global processing speed module, include, for example, the Stroop Test, Trail Making Tests, and letter or pattern comparison tasks. The Trail Making Tests can also be used to assess executive function.

Degraded Speech Module

The degraded speech module, for example a time-compression speech module, can audibly play low, and/or medium, and/or high predictability series of words (e.g., sentences), or a single word (inclusively referred to as a series for simplicity). The series of words can be on-going, contextually related words. An example series of words is, “Thirty miles was too far.” The series of words can be degraded, for example time-compressed, compared to normal speech.

The time compression can be, for example, about 60%. The time-compression can be performed using pitch-synchronous overlap and add (PSOLA). PSOLA is a method for manipulating the pitch and duration of an acoustic speech signal known to those having ordinary skill in the art.

The subject can then be asked to identify the series of words. If the subject correctly identifies the series of words, a degraded speech skill score and/or a speed of processing skill score can be increased. If the subject fails to correctly identify the series of words, the degraded speech skill score and/or the speed of processing skill score can be decreased.

The subject can repeat use of the degraded speech module. The degrading (e.g., time-compression) can vary adaptively based on performance. When the degraded speech skill score and/or the speed of processing skill score decreases, the degrading can be decreased. When the degraded speech skill score and/or the speed of processing skill score increases, the degrading can be increased.

Competing Speech Module

The competing speech module, for example, a speech in noise (i.e., speech in babble) module, can audibly play low, and/or medium, and/or high predictability series of words (e.g., sentences), or a single word (inclusively referred to as a series for simplicity) and simultaneous play noise. The speech in noise can have multiple channels. Any and/or all channels can broadcast from different speakers. The series of words can be on-going, contextually related words. An example series of words is, “The glasses were on the kitchen table.” The noise can be one or more simultaneous speech samples. The amplitude of the signal (i.e., speech) to the amplitude of the noise (i.e., signal to noise ratio) can be controlled during use of the competing speech module.

The subject can be asked to identify the series of words. If the subject correctly identifies the series of words, a competing speech skill score and/or a speech in noise skill score can be increased. If the subject fails to correctly identify the series of words, the competing speech skill score and/or the speech in noise skill score can be decreased.

The subject can repeat use of the competing speech module. The signal to noise ratios can vary adaptively based on performance. If the competing speech skill score and/or the speech in noise skill score increases, the signal to noise ratio can be lowered and/or the predictability of the series of words can be decreased. If the competing speech skill score and/or the speech in noise skill score decreases, the signal to noise ratio can be increased and/or the predictability of the series of words can be increased.

A Speech Perception in Noise (SPIN) test can be repeatedly performed to provide rehabilitation. SPIN tests can adjust the predictability of the series of words depending on the value and/or change in the competing speech and/or the speech in noise skill score.

Existing speech in noise tests that can be modified for use in the speech in noise module include, for example, QuickSIN™ (from Etymotic Research, Inc., Elk Grove Village, Ill.) and the Hearing In Noise Test (HINT®)(from Maico Diagnostics, Eden Prairie, Minn.).

Context Module

The context module, for example, a missing word module, can audibly play low, and/or medium, and/or high predictability series of words (e.g., sentences). The series of words can be on-going, contextually related words. The subject can be asked to provide linguistic closure to a series of words with a contextually appropriate word missing from the sentence.

An example series of words is, “The dog chewed on a *.” The “*” can represent a missing word. The “*” can be audibly played as a tone, masked version of the missing word, a nonsense word, another noise, or silence. The subject can be provided with multiple choices (e.g., bone, cat, tree, and wall) from which to select the missing word (e.g., bone). The context module can include a categorical hint (e.g., sports, world events, weather, celebrities, geography).

If the subject correctly identifies the missing word, a context skill score and/or a missing word skill score can be increased. If the subject fails to correctly identify the missing word, the context skill score and/or the missing word skill score can be decreased.

The subject can repeat use of the context speech module. The difficulty of the context module can vary adaptively based on performance. If the context skill score and/or the missing word skill increases, the difficulty of the context module can be increased. If the context skill score and/or the missing word skill decreases, the difficulty of the context module can be decreased.

The difficulty of the context module can be increased, for example, by increasing the length of the individual words, or the number of words in the series of words, or making the sentences more grammatically or substantively complex, or combinations thereof. The difficulty of the context module can be decreased, for example, by decreasing the length of the individual words, or the number of words in the series of words, or making the sentences less grammatically or substantively complex, or combinations thereof.

Existing context tests that can be modified for use in the context module include, for example, The Word in Context Intelligibility Test (WICIT).

Interactive Communication Module

The interactive communication module can instruct the subject on methods to improve the subject's environmental and/or personal behavior strategies to maximize the subject's neurological, for example listening, comprehension and communication effectiveness.

The interactive communication module can instruct the subject regarding beneficial listening and repair strategies, how to control the subject's environment, how to be assertive so as to improve the subject's environment (e.g., instructing the subject not to be too shy to ask someone else to repeat their speech when the speech is not understood), setting realistic expectations for their neurological (e.g., listening, comprehension or communication) performance level, how to manage the subject's stress level, how to perform speech reading at least at a basic level, understanding the Americans with Disabilities Act (ADA) and rights thereby available, skills (e.g., helpful hints) for the subject when communicating with the subject's spouse, skills (e.g., helpful hints) for the subject's spouse when communicating with the subject, restaurant skills (e.g., to ask for another table in a restaurant when the subject is sat near a noisy kitchen), hearing aid use and care, or combinations thereof.

The interactive communication module can provide rehabilitation or therapy to improve conversation skills. For example, the interactive communication module can include an adaptive assessment of sentence perception (Sent-Ident) exercise. A series of words (e.g., a set of simple sentences), for example, “Her father put the milk on the table”, can be spoken. The speaker's mouth can be visually covered from the subject's perspective. If the subject does not hear the series of words correctly, the speaker can present the series of words again, under progressively easier conditions (e.g., repetition, clarification, the speaker's mouth visible while saying one word, the speaker's mouth visible while saying all words) until the series of words is identified correctly.

The subject can be tested regarding the subject's knowledge of the information taught by the interactive communication module, for example with a basic neurological (e.g., aural) rehabilitation knowledge questionnaire. The subject's ability to respond correctly regarding the information taught by the interactive communication module can be recorded as an interactive communication skill score.

The interactive communication module can include single or repeated use of subjective tests to produce a diagnostic, therapeutic or rehabilitative effect. The subjective tests can include, for example, Abbreviated Profile of Hearing Aid Benefit (APHAB), Communication Profile for the Hearing Impaired (CPHI), Client Oriented Scale of Improvement (COSI), and other assessment methods known to those having ordinary skill in the art, or combinations thereof. APHAB is a 24-item self-assessment inventory in which patients report the amount of trouble they are having with communication or noises in various everyday situations. APHAB is known to those having ordinary skill in the art. CPHI is a self-assessment inventory that communication effectiveness, communication importance, communication environment, communication strategies, and personal adjustment in hearing-impaired adults. COSI is known to those having ordinary skill in the art. The results from the assessment tools and the skill scores supra can be combined into appropriately titled skill scores. The subject can perform self-evaluation of rehabilitation performance.

A total and/or sub-total skill scores can be computed as functions of the skill scores for the modules. When a module is initially performed with a given subject, that subject's skill scores can be recorded as baseline scores for future reference. The skill scores can be tracked over time to determine a subject's change in listening and comprehension. If the skill scores decrease over time, the difficulty of the modules can be decreased. If the skill scores increase over time, the difficulty of the modules can be increased.

The inventive method can enhance and improve listening, comprehension and communication skills and improve confidence levels. The inventive method can improve cognitive function, and/or contextual skills, and/or linguistic skills, and/or temporal processing, and/or interactive communication skills.

The audibly played text and other substantive data used in the modules, can be selected to be topically relevant to the subject's personal selection, and can be updated to maintain timely relevance (e.g., news feeds). For example, the modules can contain text and substantive data that can be particularly relevant to dogs for “dog-loving” subjects, and particularly relevant to politics for “politics-loving” subjects.

The modules can be provided for the subject to take to the subject's home and/or perform at the subject's home. The modules can be recorded onto digital media (CD-ROM) and, for example, used on the subject's home computer. The modules can be performed on a personal digital assistant (PDA), and/or other portable handheld devices. The subject's progress can be monitored remotely, for example by a health professional.

“The case for LACE, individualized listening and auditory communication enhancement training”: Sweetow, R. W. and Henderson-Sabes, J. H.: The Hearing Journal, Vol. 57, No. 3, 32-40, 2004 is herein incorporated by reference in its entirety. The rehabilitation methods disclosed herein can be performed on subjects with or without hearing aids.

Subject Data

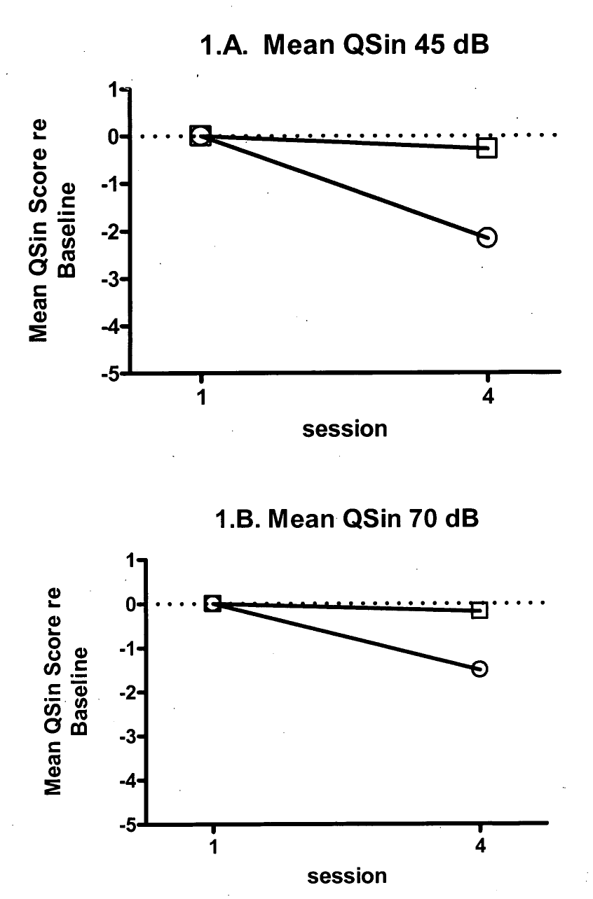

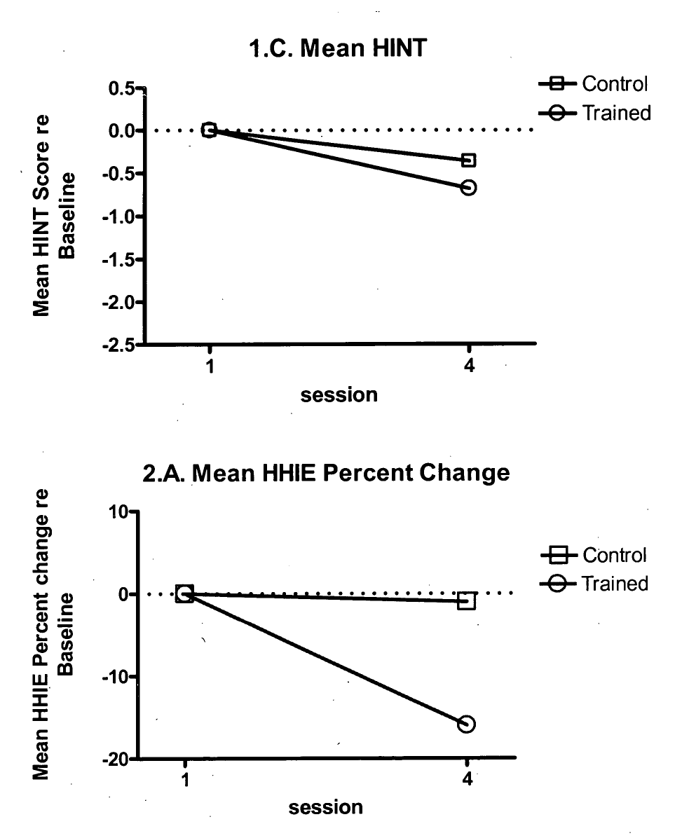

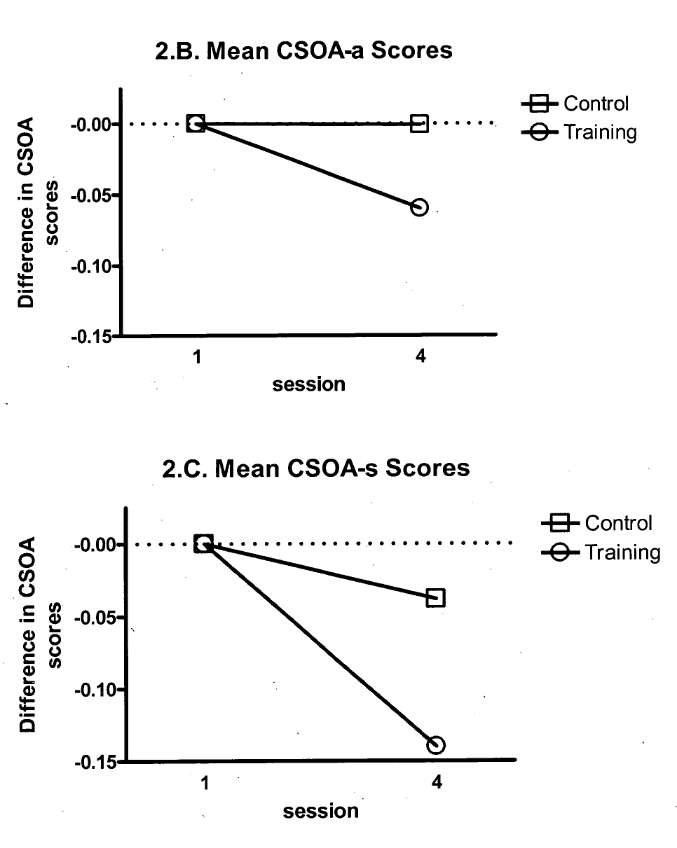

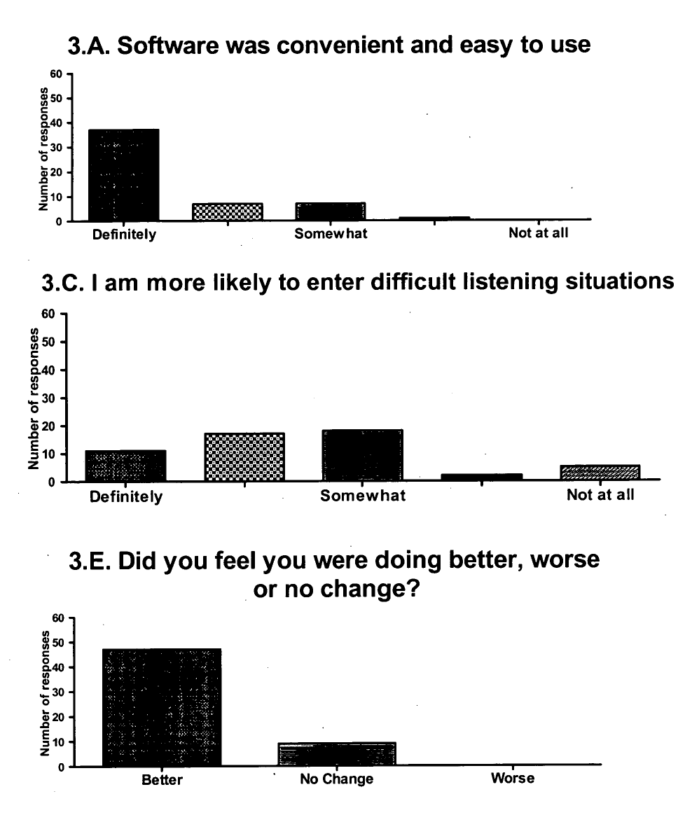

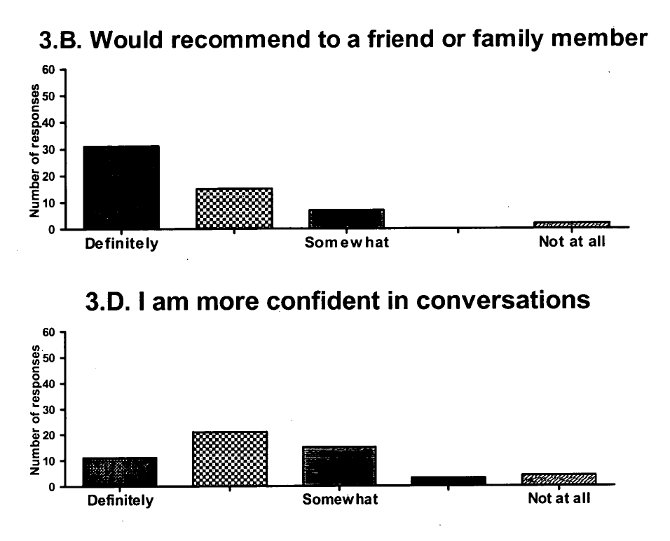

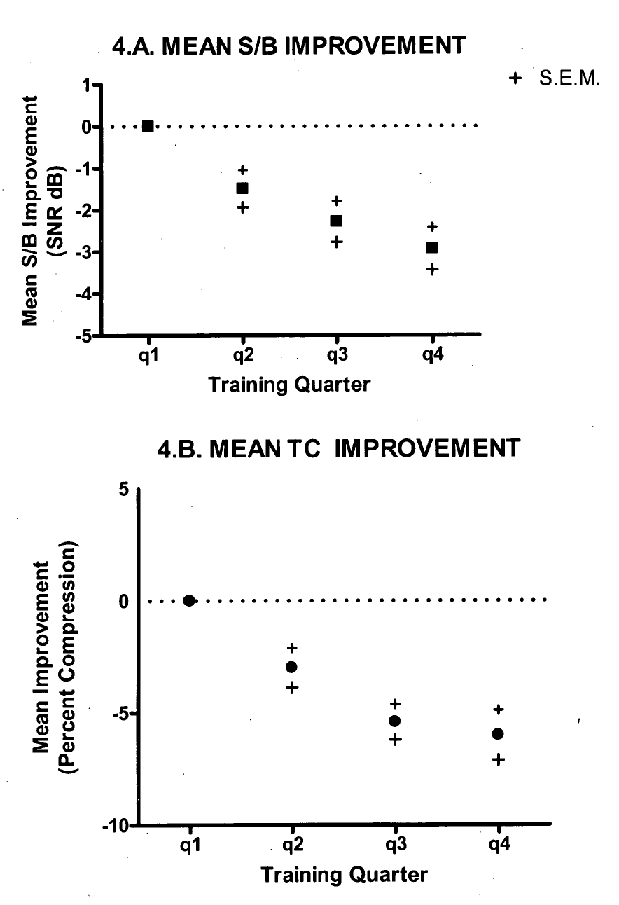

A randomized cross-over design multi-site study was conducted to determine the efficacy of the methods disclosed herein. Fifty subjects (“trained group”) performed training with the methods disclosed herein for four weeks. The training included training each day with one, two to three modules for 30 minutes for each module for five days per week. Thirty control subjects (“control group”) did not perform the methods disclosed herein. Performance data were collected from the trained group and the control group. The performance data demonstrated statistically significant improvements in hearing performance for the trained group compared to the control group on objective measures (e.g., improvements in speech recognition for degraded conditions such as background noise, shown in FIGS. 1A through 1C,) and subjective measures (e.g., the standardized Hearing Handicap for Elderly (HHIE), Hearing Handicap for Adults, and Communication Strategies for Older Adults (CS OA), shown in FIGS. 2A through 2C, and survey responses shown in FIGS. 3A through 3E).

The performance data shown in FIGS. 1A through 1C and 2A through 2C were collected from the subjects at a baseline session (session 1) and a session 4 weeks later (session 4). A decrease in score indicates an improvement in the subject's real or perceived hearing. The dotted line indicates no change in score.

FIG. 1A illustrates average subject performance data for the trained (shown as squares) and the control (shown as circles) groups for the QuickSIN™ competing speech module at 45 dB. FIG. 1B illustrates average subject performance data for the trained (shown as squares) and the control (shown as circles) groups for the QuickSIN™ competing speech module at 70 dB. FIG. 1C illustrates average subject performance data for the trained (shown as squares) and the control (shown as circles) groups for the HINT competing speech module.

FIG. 2A illustrates the average subject performance data for the trained (squares) and the control (circles) groups on the Hearing Handicap Inventory for the Elderly or Adults (HHIE). The HHIE is a subjective measure of the subjects' handicap due to hearing loss. A lower score on the HHIE indicates that the subject perceives less hearing handicap.

FIG. 2B illustrates the average subject performance data for the trained (squares) and the control (circles) groups on the Communication Scale for Older Adults Attitudes (CSOA-a). The CSOA-a is a subjective measure of the subjects' attitudes. A lower score on this test indicates better attitudes regarding hearing loss.

FIG. 2C illustrates the average subject performance data for the trained (squares) and the control (circles) groups on the Communication Scale for Older Adults Strategies (CSOA-s). The CSOA-s is a subjective measure of the subjects' strategies. A lower score on this test indicates better strategies regarding hearing loss utilized in daily life.

FIGS. 3A through 3E illustrate responses by the trained group to survey questions regarding the subjects' impressions about the testing and results. The survey results confirmed the fact that methods disclosed herein are an efficacious and effective method for providing training.

FIG. 3A illustrates the responses to the question: was the software convenient and easy to use? FIG. 3B illustrates the responses to the question: would you recommend the methods used herein to a friend or family member? FIG. 3C illustrates the responses to the question: are you more likely to enter difficult listening situations? FIG. 3D illustrates the responses to the question: are you more confident in conversations? FIG. 3E illustrates the responses to the question: did you feel you were doing better, worse or was there no change during the training?

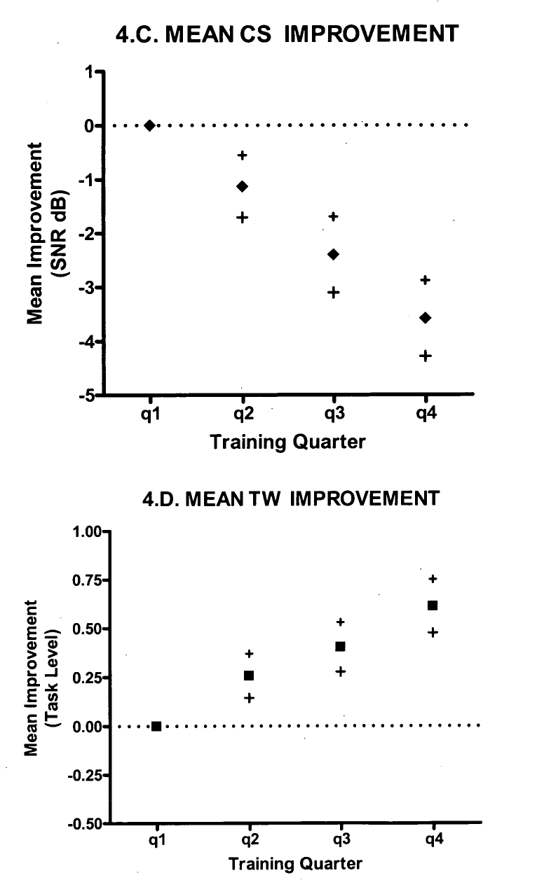

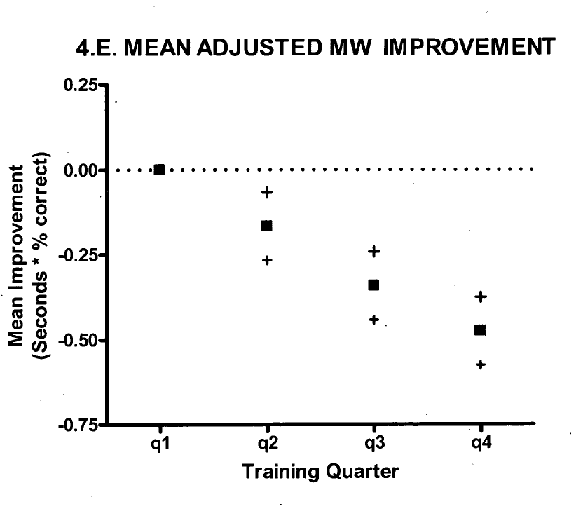

The performance data shown in FIGS. 4A through 4E were collected from the subjects at a baseline session (q1) and at three sessions (q2, q3 and q4) following the baseline session. The time between each session was one week. FIGS. 4A through 4E illustrate average improvement scores for the trained subjects on the training tasks. Average scores are indicated for each quarter of the training, with the standard error noted by crosshatches. All tasks showed significant improvement by the 3^{rd} quarter of training.

A decrease in score on the Speech in Noise (e.g., Babble) (S/B, shown in FIG. 4A), Time Compressed Speech (TC, shown in FIG. 4B), Competing Speaker (CS, shown in FIG. 4C) and the Missing Word (MW, shown in FIG. 4E) modules indicate improvement in the subject's hearing. A higher score on the Target Word module (TW, shown in FIG. 4D) indicates improvement in the subject's hearing. The dotted line indicates no change in score.

FIG. 4A illustrates the improvement of the average subject's ability to distinguish speech in noise, with the speech to noise ratio in decibels. FIG. 4B illustrates the improvement of the average subject's time compression of time compressed speech. FIG. 4C illustrates the improvement of the average subject's ability to understand one of competing speakers, with the speech to noise ratio in decibels. The noise was the competing, not the desired, speech. FIG. 4D illustrates the improvement of the average subject's task level for determining the target word in the Target Word module. FIG. 4E illustrates the improvement of the average subject's time for performing the Missing Word module.

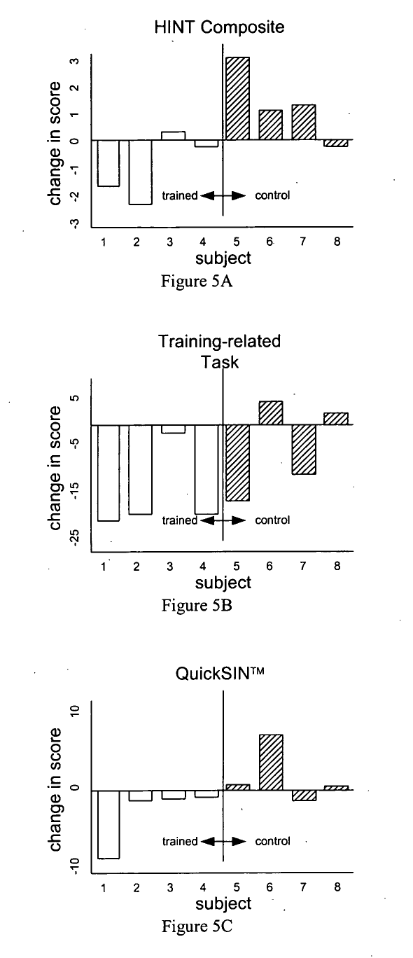

Additional testing was performed. The testing protocol is described in U.S. Provisional Application No. 60/479,039, which is incorporated by reference in its entirety. The results are shown in FIGS. 5A-5C. FIGS. 5A through 5C illustrate changes between baseline and post-testing scores for the trained group (four subjects) and the control group (four subjects) based on the protocol disclosed supra. FIG. 5A illustrates changes in HINT scores. FIG. 5B illustrates changes in training-related task scores. The training related tasks include the first-order task, hearing; the second-order task, listening, for example measure with the HINT or SIN test or QuickSIN™; and the third-order task, comprehension, for example measured with the SPIN test. FIG. 5C illustrates changes in QuickSIN™ scores. Note that changes in the negative direction indicate performance improvements. As shown, three of the four trained subjects had improved scores on all three tests administered. This data and the other data provided herein illustrate that embodiments of the invention produce advantageous results.

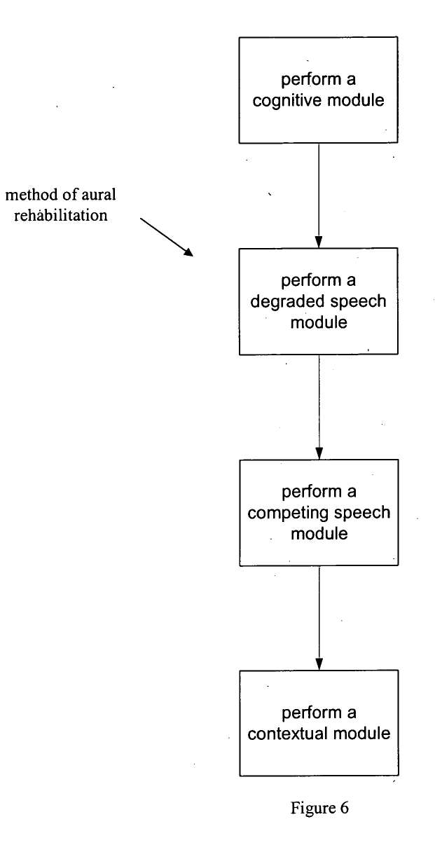

FIG. 6 illustrates a method for aural rehabilitation. The method can include performing a cognitive module, then performing a degraded speech module, then performing a competing speech module, then performing a contextual module. The modules can be performed in any order and in any combination, for example more than one of a specific module can be used during a single session.

Any of the above-described modules and any functions described herein may be implemented as software code to be executed by a processor using any suitable computer language such as, for example, Java, C++ or Perl using, for example, conventional or object-oriented techniques. For example, an embodiment of the invention may be directed to software which comprises code for performing at least one of a cognitive module, a degraded speech module, a competing speech module, and a contextual module. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus may be present on or within different computational apparatuses.

It is apparent to one skilled in the art that various changes and modifications can be made to this disclosure, and equivalents employed, without departing from the spirit and scope of the invention. For example, audibly playing data to a subject can also be performed by silently visually displaying the data, or by a combination of audibly playing the data and visually displaying the data. Elements shown with any embodiment are exemplary for the specific embodiment and can be used on other embodiments within this disclosure.

1. A method for aural rehabilitation comprising:
performing a first module, and performing a second module, wherein the first and second modules are selected from a group of module types consisting of: a cognitive module, a degraded speech module, a competing speech module, a contextual module, and an interactive communication module.

2. The method of claim 1, wherein the first module is a different module type than the second module.

3. The method of claim 1, wherein the method comprises performing a third module.

4. The method of claim 3, wherein the first module is a different module type than the second module, and wherein the third module is a different module type from the first and second modules.

5. The method of claim 3, wherein the method comprises performing a fourth type of module.

6. The method of claim 5, wherein the first module is a different module type than the second module, and wherein the third module is a different module type from the first and second modules, and wherein the fourth module is a different module type from the first, second and third modules.

7. The method of claim 6, wherein the method comprises performing a fifth type of module.

8. The method of claim 7, wherein the first module is a different module type than the second module, and wherein the third module is a different module type from the first and second modules, and wherein the fourth module is a different module type from the first, second and third modules, and wherein the fifth module is a different module type from the first, second, third, and fourth modules.

9. A method for aural rehabilitation comprising:
performing a degraded speech module; and
performing a competing speech module.

10. The method of claim 9, further comprising performing a contextual module.

11. The method of claim 10, further comprising performing a cognitive module.

12. The method of claim 11, further comprising performing a interactive communication module.

13. A method for aural rehabilitation comprising performing a speed of processing module.

14. The method of claim 13, wherein the speed of processing module comprises displaying a first color.

15. The method of claim 14, wherein the speed of processing module further comprises displaying a text name of a second color on the first color.

16. The method of claim 15, wherein the speed of processing module comprises a Stroop test.
